(19) United States
(12) Patent Application Publication
(10) Pub. No.: US 2018/0001576 A1
(43) Pub. Date: Jan. 4, 2018

(54) METHOD FOR PRODUCING AN AEROGEL MATERIAL

(71) Applicant: EMPA EIDGENOSSISCHE MATERIALPRUFUNGS- UND FORSCHUNGSANSTALT, DUBENDORF (CH)

(72) Inventors: MATTHIAS KOEBEL, BRUTTISELLEN (CH); LUKAS HUBER, DUBENDORF (CH)

(73) Assignee: EMPA EIDGENOSSISCHE MATERIALPRUFUNGS- UND FORSCHUNGSANSTALT, DUBENDORF (CH)

(21) Appl. No.: 15/548,557

(22) PCT Filed: Feb. 4, 2016
(86) PCT No.: PCT/EP2016/052359

§ 371 Date: Aug. 3, 2017

(30) Foreign Application Priority Data
Feb. 4, 2015 (EP) 15153869.1

(51) Int. Cl. B29C 67/20; B01J 13/00; C01B 33/155; C08J 9/28; C01B 33/158; C01B 33/145; B29K 105/00; B29K 75/00

(52) U.S. Cl. CPC B29C 67/202; C01B 33/1585; B01J 13/0039; B01J 13/0065; B01J 13/0091; C01B 33/145; C01B 33/155; B01J 13/0026; C08J 9/28; B29K 2075/00; C01P 2006/16; B29K 2105/0061; C08J 2201/05; C08J 2205/026; C08J 2205/042; C08J 2205/044; C08J 2375/04

(57) ABSTRACT

The invention relates to a method for producing an aerogel material with a porosity of at least 0.55 and an average pore size of 10 nm to 500 nm, having the following steps: a) preparing and optionally activating a sol; b) filling the sol into a casting mold (10); c) gelling the sol, whereby a gel is produced, and subsequently aging the gel; at least one of the following steps d) and e), d) substituting the pore liquid with a solvent; e) chemically modifying the aged and optionally solvent-substituted gel (6) using a reaction agent; followed by f) drying the gel, whereby the aerogel material is formed. The casting mold used in step b) is provided with a plurality of channel-forming elements (2) which are designed such that the sol filled into the casting mold lies overall at a maximum distance X from a channel-forming element over a specified minimum length L defined in the channel direction of the elements, with the proviso that X<15 mm and L/X>3.

This application claims priority from PCT application No. PCT/EP2016/052359 filed Feb. 4, 2016 which claims priory from European application No. EP 15153869.1 filed on Feb. 4, 2015, the disclosures of which are incorporated herein by reference,

### TECHNICAL FIELD

The invention relates to a process for the simplified production of an aerogel material , to precursor products, and also to an aerogel plate.

### BACKGROUND OF THE INVENTION

Aerogels are being increasingly applied in highly specialized niche markets such as in building technology in the form of highly insulating insulation materials but also in aerospace and shipbuilding industry and in high-tech applications. Aerogels are available as various embodiments and materials. The industrialization of aerogels and xerogels has experienced a significant surge since the turn of the millennium. Nowadays, particularly silicate-based (SiO₂) aerogels are available, The best-known forms include granulates and monolithic plates. Moreover, aerogels based on at least partially crosslinked polymers are also well-known, such as the resin-based resorcinol formaldehyde system [Pekala et. al, J. Mater. Sci, 1989, 24, 3221-3227], but also some related systems which until today have not gained any industrial importance. The industrial process scaling of alternative polymer-based aerogels, in particular poly-isocyanate-based aerogels such as PU and PUR, is fully underway currently with various new market launches to be expected in the next few years. In future, silicate- and polymer-based aerogels as well as carbon aerogels obtained by pyrolysis from the latter will become increasingly important in building and energy technology as well as in the areas of mobility and high-tech applications.

A critical step in the production of aerogel materials is the drying of a wet gel, In earlier times, supercritical drying, i.e. drying from a supercritical fluid (typically lower alcohols and later also CO₂), was exclusively used for silicate-based gels. In the case of the silicate aerogels, materials can be produced with virtually identical properties as the supercritically dried aerogels by using solvent drying (subcritical drying) of hydrophobicized gels. According to the classic definition, these materials used to be called xerogels, a term that is still being used also today for aerogels dried from solvents, However, hereinafter, the definition based on a material's properties (density<0.20 g/cm³, porosity>85%, void size 20 to 80 nm) will also used for subcritically dried materials, which are also termed as aerogels. The development of solvent drying processes for organic gels (e.g. polyurethane and polyurea) is currently in full progress.

The main cost contributors for the aerogels, which presently are still comparatively expensive, are due to the demanding processing, solvent, solvent losses and concomitant VOC releases as well as raw materials and hydrophobicization agents. Further development of the production processes aims at savings in all of the mentioned items, with the following development steps having been achieved as of today. An increasing significance is nowadays attributed to the simplified drying from solvent-containing gels at atmospheric pressure, which was first described for SiO₂ aerogels by Anderson, Scherer and their coworkers [J. Non. Cryst. Solids, 1995, 186, 104-112]. The process became known rapidly and spurred new processes for silicate aerogel production, Patent U.S. Pat. No. 5,565,142 describes such a production process. The solvent exchange times and hydrophobicizing times are mentioned as about 120 hours in total, with the dimension or shape of the gel body not being described further.

WO 1998/005591 A1 relates to a process for producing organically modified permanently hydrophobic aerogels. Like in the case of WO 1995/006617 A1 the SiO₂ gel is formed starting from a water glass solution by means of neutralization with acid or, after formation of a silica sol, by ion exchange and subsequent addition of a base. The pH value during the gelation typically lies in the range between 4 and 8. The wet gel is washed with an organic solvent until the water content is below 5%, and then hydrophobicized. Drying under atmospheric pressure by evaporation of the solvent leaves the aerogel material as granulate material. The dimension and shape of the gel bodies are not further described also in this publication. Also, the washing and hydrophobicizing times are not further described, but grinding of the solidified gel is explicitly mentioned.

As examples of organic aerogels, U.S. Pat. No. 5,484,818 and U.S. Pat. No. 2006/0211840 A1 describe the preparation of polyisocyanate-based aerogels. Isocyanate precursor compounds are dissolved in an organic solvent mixture and are reacted with polyols, polyamines or water, gelled and supercritically dried after solvent exchange with CO₂. The two above mentioned patents appear to be representative for the majority of the technical documents on polymer aerogels in that they describe the chemistry, but not the processing-specific method steps: There is generally little documentation on the type of the gel bodies and their shape or their exact topology. U.S. Pat. No. 5,962,539 A describes a process for the supercritical drying of organic gels. Also in this case there is no information on the form or shape of the gel.

It is known that solvent exchange processes in nanoporous systems are diffusion-limited, which in some situations results in undesirably long exchange times. As a simple measure, diffusion processes can be accelerated by temperature increase. This is already exploited in aerogel production today by carrying out exchange processes in organic solvents, often as close as possible to their boiling point.

As an alternative, aerogels are produced either as granulate or thin mats or plates with a shortest dimension or thickness of less than 2 cm, which are then glued together in one or more refining steps. It is thus possible to produce thicker insulation panels or other, in some cases also functional, composite materials. US 2014/0004290 A1 and US 2014/0287641 A1 describe such manufacturing processes of composite materials starting from aerogel as a basic material by adhesive technology, whereby the main emphasis is placed on improved mechanical properties and processability. WO 2012/062370 A1 describes a similar process in which a resorcinol-formaldehyde resin system in xerogel form is used as adhesive component.

In the technical production of aerogel granulate, the dimensionality of the gel is determined by fragmentation before the solvent exchange by mechanical processes or by gelation in droplet form in a precipitation tower. The first process has been industrially established since in this way a much better utilization of space can be achieved in the system. The state of the art is formation of a gel carpet by gelation on a running belt and fragmentation of the aged gel carpet over a breaker. However, the occurring shear forces have the consequence that, in addition to the desired granulate particles in the size range of 1 to 5 mm, also a considerable amount of the gel remains as a fine fraction <1 mm. This fine fraction can be up to 30% of the total yield and is considered as an inferior product in the production.

In all of the above-mentioned examples, it would be desirable to improve the production processes in such a way that, among others, an increased throughput is achieved. A possible improvement of the process can be judged in terms of the process efficiency as compared to the state of the art, i.e. as the maximum throughput of the desired end product which is technically feasible in a given installation.

### SUMMARY OF THE INVENTION

It is an object of the invention to provide an improved process for the production of aerogel materials. Further objects are to provide precursor products for producing an aerogel plate and also to provide a new aerogel plate.

The process for the production of an aerogel material with a porosity of at least 0.55 and an average pore size of 10 nm to 500 nm of the present invention comprises the following steps:

a) preparing and optionally activating a sol;

b) filling the sol into a casting mold;

c) gelling the sol, whereby a gel is produced, and subsequently aging the gel; at least one of the following steps d) and e)

d) exchanging the pore liquid with a solvent;

e) chemically modifying the aged and optionally solvent-exchanged gel using a reacting agent; followed by

f) drying the gel, whereby the aerogel material is formed.

According to the present invention the casting mold used in step b) is provided with a plurality of channel-forming elements which are configured such that, along a specified minimum length L defined in the channel direction of the elements, every location of the sol filled into the casting mold has a maximum distance X from a channel-forming element fulfilling the provision that X≦15 mm and L/X>3.

The sol filled into the casting mold has at every location thereof—along a specified minimum length L defined in the channel direction of the elements—a maximum distance X from a channel-forming element. When viewing a cross-section perpendicular to the channel direction, this means that no location in the sol is further away than X from the next channel-forming element. This ensures that even the innermost regions in the sol are not too distant, namely at most by a maximum distance X, from the boundary surface defined by the channel-forming element. By virtue of the fact that X is at most 15 mm, any point in the gel is efficiently accessible for a solvent or reaction agent supplied through said interface. However, this advantageous geometrical situation shall not be provided merely at individual constrictions present along the channel direction, but rather shall be realized over a distance L that is at least 3 times the maximum distance X.

It needs be noted that the term “maximum distance” shall not be misunderstood as an absolute maximum distance. Rather than that, it is the maximum of all shortest distances. In other words, the “maximum distance” in the sense of the present invention is the shortest distance between the innermost point of a cross-sectional area and the boundary surface defined by the channel-forming element.

It shall be understood that the maximum distance X depends on the shape and, in certain cases, also on the mutual spacing of the channel-forming elements. The corresponding relations result from known relationships of planar geometry. In the case of complicated and/or irregular shapes, the maximum distance may have to be determined numerically.

The formation of an aerogel starting from a sol is basically known and includes, in particular, a step of solvent exchange and/or a step of chemical modification. By virtue of the arrangement according to the present invention, a significantly improved accessibility of the gel for the supplied solvent and/or reaction medium is ensured. This results in a shortening of the process duration and as a consequence thereof also in an improvement in process economy. These advantages apply not only to already known aerogel production process, but also to any future processes which still need to be developed, provided that these are also based on the supply of a liquid or possibly gaseous species into the gel.

By specifically selecting the geometry i.e. by limiting dimensional extension in at least one spatial direction, a substantial acceleration of the diffusion-limited solvent exchange processes can be achieved. In this way it is possible, for example, to accomplish an exchange from one solvent mixture to another solvent mixture in large-area, monolithic gel plates with a thickness of a few millimeters, within a time that is reasonable from the point of view of an industrial production process. A silicate-based gel plate with a 50 nm medium pore size and a 5 mm thickness can be exchanged completely (i.e., all the way through the depth of the plate) in an alcohol-based solvent mixture at room temperature within a few hours, The diffusion rate is given by the solution of Fick's 2nd law: In the case of a gel plate, the time required for solvent extraction (until the concentrations of all solvent components have reached equilibrium) depends in a first approximation on the square of the plate thickness, which is the shortest dimension. This means that doubling of the plate thickness results in quadrupling the exchange time. This has profound consequences on industrial production processes of aerogel and xerogel materials: In practice, depending on the system, aerogel plates of 2 to 3 cm can still be produced with a reasonable time consumption. However, a thickness of 10 cm, which would be desirable, for example, in insulation technology, cannot be produced as a solid material in an economic manner with current technology.

As compared to the presently known processes, the process of the present invention allows for a substantially simpler and faster production of aerogel materials by controlled structuring of the gel body, whereby process efficiency and throughput can be markedly increased.

In principle, for the production of the casting mold, i.e. of the outer housing and also for any pipe or rod elements that are employed, various materials can be used. These include, for example, polyolefins, in particular polypropylene or polyethylene, but also glass or ceramics and metals such as, for example, stainless steel. In any case, when selecting materials, it will be necessary to ensure compatibility with the media to be used (acid, base, solvent).

According to one embodiment the channel-forming elements are configured as bundles of pipes arranged parallel to each other, wherein the casting mold for the sol is formed by the interior spaces of the pipes, and wherein the solvent exchange d) and/or the chemical modification of the gel e) is carried out directly in the casting mold across an interspace between the gel and the channel-forming element formed as a result of a shrinkage during the aging of the gel c), preferably by means of forced convection of supplied solvent or reaction medium. It will be understood that in this type of arrangement the maximum distance X is to be determined by considering the distance that a point located in the interior of the pipe has from the inner surface of the respective pipe element.

In principle, various shapes of the pipe cross-section can be used. Advantageously, it will be pipes with a circular or square, particularly a square internal profile. Moreover, it is advantageous for handling if a certain number of pipes are held together to form a pipe bundle.

In an advantageous embodiment all pipes have an identical cross-section, which is preferably hexagonal. This allows building compact pipe bundles with little dead volume between the individual pipes.

In a further embodiment the optionally solvent-exchanged and optionally chemically modified gel is removed as gel rods from the casting mold and subsequently the drying f) is carried out by means of subcritical drying. In this process, the individual gel rods disintegrate into smaller fragments, whereby advantageously an aerogel or xerogel granulate with only minimal fine fraction is produced.

According to a further embodiment the channel-forming elements are configured as bundles of rod elements arranged parallel to each other, wherein the casting mold for the sol is formed by a space located between the rod elements, and wherein the rod elements are withdrawable from the casting mold in channel direction after gelation and aging in such manner that a plate-shaped gel body with continuous channels is formed. The solvent exchange d) and/or the chemical modification of the gel e) is carried out by applying solvent or reaction agent. It is understood that in this type of arrangement, the rod elements act as place holders for channels to be formed subsequently in the aged gel. Accordingly, the maximum distance X is to be determined by considering the distance which a point located between the rod elements has from the outer surface of the nearest rod element.

In principle, various shapes of the pipe cross-section can be used. Advantageously, it will be rods with a circular or tetragonal, particularly square, or a hexagonal external profile.

In one embodiment, the application of solvent or reaction agent is carried out on a previously formed plate-shaped gel body after removing the same from the casting mold.

Advantageously, the rod elements are attached at one end thereof to a removable bottom surface or cover surface of the casting mold and can thus be easily pulled out of the gel body after aging of the gel.

It is particularly advantageous, if the application of solvent or reaction agent is carried out by means of forced convection by placing the gel body onto a suction plate that is at least partially permeable and applying on the underside thereof a vacuum so as to draw off the solvent or reaction agent, the new solvent or reaction agent being supplied from above the gel body. Such processes are basically known, in particular, from paper production.

A process has been found to be advantageous in which
the sol is prepared as a silicon oxide sol in an alcoholic solvent mixture containing at least one acid-catalytically activatable hydrophobicization agent, wherein the volume fraction of the hydrophobicization agent in the sol is 5 to 60%,
the gelation of the sol is initiated by addition of a base;
a chemical modification of the aged gel is carried out, wherein the chemical modification is a hydrophobicization initiated by the release or the addition of at least one hydrophobicization catalyst interacting with the hydrophobicization agent; and
the drying of the gel is carried out by means of subcritical drying.

In this case, the activation of the hydrophobicization agent can be triggered by the addition of a small amount, typically in the range of 10 to 20% of the gel volume, of an acidic hydrophobicization catalyst dissolved in a compatible solvent mixture. In order to ensure a homogeneous hydrophobicization in the gel material, the hydrophobicization agent must, however, also diffuse into the depth of the gel material, whereby the shape and the characteristics of the gel body have an important effect on the time required for the hydrophobicization step. According to the invention, the introduction of the hydrophobicization catalyst in amounts that are small compared to the gel volume can again be realized in a significantly simpler and more economic manner by providing the gel with a specific structure.

By virtue of the fact that hydrophobicization is an acid-catalyzed process, i.e. is catalyzed by H⁺ and H₃O⁺ ions, respectively, the gelation process, which occurs under slightly basic conditions, and the hydrophobicization process, which occurs under acidic conditions, can be carried out in one and the same organogel but nonetheless well-separated from each other temporally. As a further advantage, the process stands out for its significantly reduced solvent consumption. In particular, it is possible to limit the solvent amount used for the production of an aerogel to 1.1 to 1.2 times the gel volume. According to present state of the art, typically more than 2 times the gel volume is needed.

In the present context, an alcoholic solvent mixture shall be understood as a mixture that essentially consists of one, or optionally several, lower alcohols (in particular ethanol, methanol, n-propanol, isopropanol, butanols) and an appropriate proportion of a hydrophobicization agent. It will be understood that the mixture can furthermore contain a small proportion of water, unavoidable impurities and optionally—as explained elsewhere—certain additives.

A hydrophobicization agent shall be understood in generally known manner as a component which provides hydrophobic, i.e. water-repellent properties. In the present context, the hydrophobicization agent and the hydrophobicization process relate primarily to the silicate gel and to the modifications of the properties thereof.

The advantageous embodiment comprises gelation of an alkoxide-based silicate sol in an alcoholic solvent mixture that contains at least one catalytically activatable hydrophobicization agent.

The gelation process is initiated by addition of a diluted base such as ammonia. Optionally, the gel thus formed, which can also be referred to as “organogel”, is further subjected to an aging process. The optionally aged gel now contains all of the components that are required for the hydrophobicization and for the subcritical drying according to WO2013/053951 A1 or, more specifically, it contains a pore liquid with alcohol and activatable hydrophobicization agent as the main components, but not with the hydrophobicization catalyst.

Subsequently it is necessary to introduce into the gel the hydrophobicization catalyst in a controlled manner completely and without additional solvent addition or with just a minimal solvent addition. According to a preferred embodiment hexamethyldisiloxane (HMSO) is used as the acid-catalytically activatable hydrophobicization agent.

It is particularly advantageous if the volume fraction of the hydrophobicization agent in the sol is 20 to 50%, particularly 25% to 40% and more particularly 34% to 38%.

According to a further embodiment trimethylchlorosilane (TMCS) and/or HCl in an alcoholic solution or a mixture of these two components is used as hydrophobicization catalyst, which is dissolved in a diluted solvent mixture having a similar or identical composition as the pore liquid and which is brought into contact with the gel in the liquid phase. The amount of catalyst charged solvent as compared to the gel volume shall be kept as small as possible in order to maintain the benefit of keeping the solvent balance as low as possible. Preferably, the catalyst-containing solution in a batch process or in a continuous process shall represent a volume fraction and volume flow fraction of maximally 30%, particularly of maximally 10%. Instead of HCl, it is also possible to use other mineral acids, whereby nitric acid (HNO₃) has been found to be particularly advantageous.

According to another embodiment of the process the gel is a polymer-based gel, preferably a polyisocyanate-based gel.

For certain applications with increased structural stability requirements, it has been found to be advantageous to add the optionally activated sol to a fiber-based matrix before the gelation. In this manner fiber-reinforced aerogel plates can be produced.

According to a further aspect of the invention, there is provided a first precursor product for producing an aerogel material, which first precursor product consists of an aerogel plate according to the present invention that is provided with longitudinal holes. The longitudinal holes can be through-channels extending perpendicularly through the plate plane or corresponding blind holes with only one-sided opening. In particular, the longitudinal holes can be produced by a process as defined above, wherein the dimensions of the holes are substantially defined by the outer dimensions of the rod elements used. However, it is necessary to take into account the shrinkage occurring during aging of the gel.

According to another aspect of the invention, there is provided a second precursor product for producing an aerogel plate, which second precursor product consists of a plurality of aerogel rods. In particular, these rods can be produced by a process as defined above, wherein the outer dimensions of the aerogel rods are substantially defined by the inner dimensions of the pipe elements However, also in this case the shrinkage occurring during aging of the gel must be taken into account.

According to a further aspect of the invention, there is provided an aerogel plate which comprises a first precursor product in the form of an aerogel plate, into the longitudinal holes of which are inserted or pressed correspondingly shaped aerogel rods of a second precursor product. In this case the same material can be used, in principle, for the aerogel plate and for the aerogel rods. In this way, one can first produce the plate element with the advantages of the process of the present invention, The longitudinal holes, which ultimately are undesirable in the aerogel plate to be produced as they would result in a considerable reduction in the heat insulation capacity, can be removed by inserting the aerogel rods. However, there are also other applications conceivable in which the inserted aerogel rods are made of a different material, which in particular allows for an improvement of the mechanical and thermal properties of the end product. For example, an aerogel plate formed from a silicate-based gel and provided with continuous longitudinal holes can be provided with inserted aerogel rods made of a polyurethane gel.

### BRIEF DESCRIPTION OF THE DRAWINGS

Examples of the invention will henceforth be described in more detail with reference to the drawings, which show:

FIG. 1 a schematic view of distance relations in various arrangements: (a) square pipe profile, (b) circular pipe profile, (c) arrangement with several circular pipe profiles, (d) hexagonal pipe profile, (e) arrangement with several hexagonal pipe profiles, (f) orthonormal arrangement of circular rods and (g) hexagonal arrangement of circular rods;

FIG. 2 (a) to (d) the step sequence of a first embodiment of the process; and

FIG. 3 (a) to (e) the step sequence of a second embodiment of the process.

### DESCRIPTION OF THE PREFERRED EMBODIMENTS

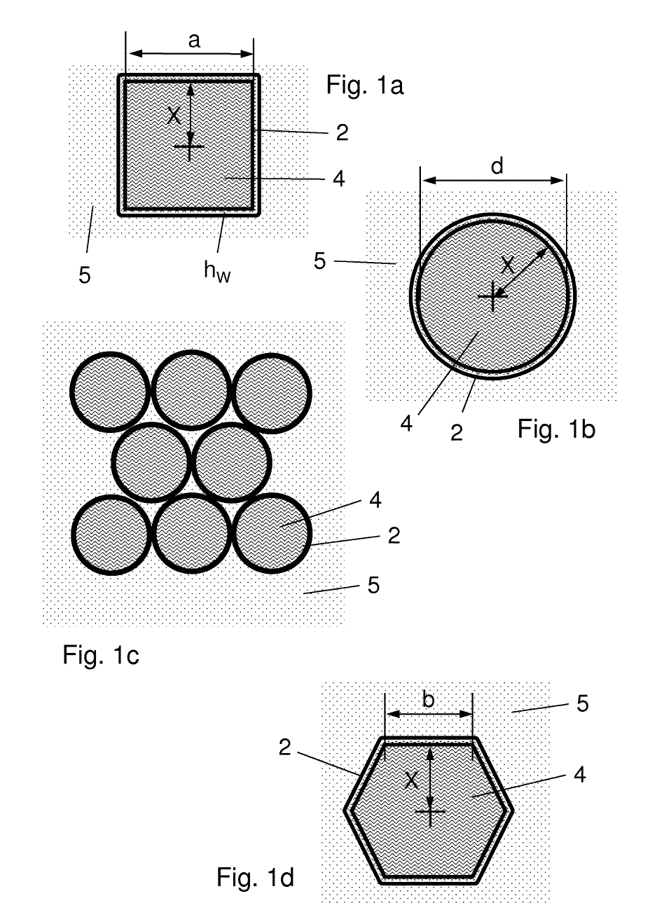

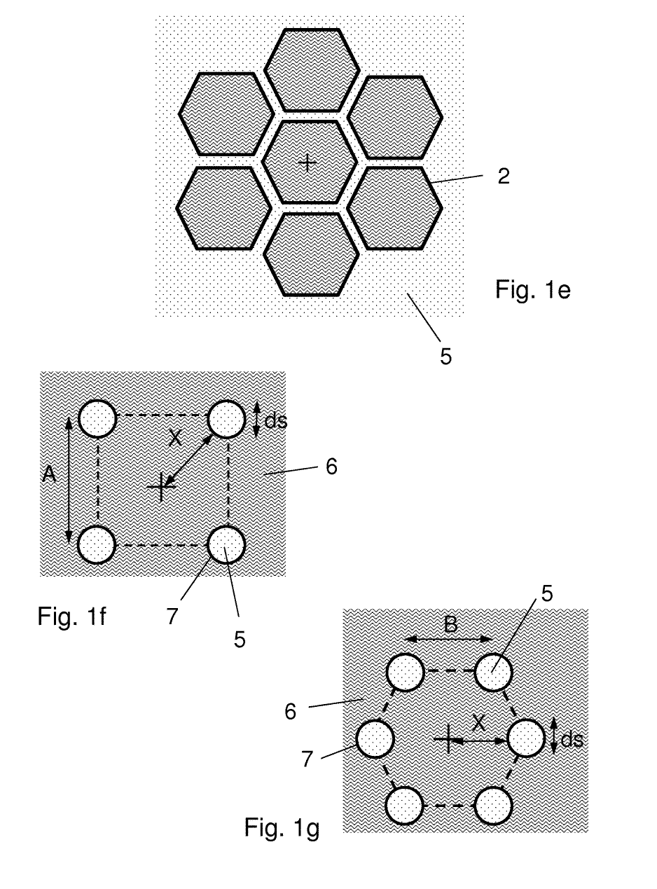

FIG. 1 illustrates some basic geometric shapes and relations. In the figures, the innermost point which has the distance farthest away from the next channel-forming element is shown with a cross. Also shown is the maximum distance X defined in the above-mentioned sense, which is the shortest distance that the innermost point has from the next channel-forming element.

FIGS. 1a to 1e show a situation in which the pipe components 2 used as channel-forming elements and also a sol contained therein or a still unaged gel 4 formed therefrom can be seen. For better illustration, these figures also show a solvent or a reaction agent 5 for the steps d) or e) described above, which should penetrate into the previously aged gel after removal of the pipe components. FIGS. 1f and 1g show another situation in which the channel formation in an aged gel material 6 by means of rod elements has already been completed: the rod elements were removed and circular channels 7 were formed into which the reaction agent 5 was filled.

In the square pipe profiles with inner edge length a shown in FIG. 1a, the maximum distance X is =a/2. As already mentioned, this is the shortest distance from the innermost point within the profile. In the circular profile with internal diameter d shown in FIG. 1b the maximum distance X is d/2. In the regular hexagonal pipe profile with inner edge length b shown in FIG. 1d the maximum distance X is =b/2 √3.

FIGS. 1c and 1e show arrangements of tightly packed circular or hexagonal pipe profiles.

In the case of the orthonormal lattice grid indicated in FIG. 1f, in the lattice points of which the channel-forming circular rods are arranged and which consists of a plurality of square elementary cells with side length A, the maximum distance is given by X=½ (A√2−ds).

In the case of the hexagonal lattice grid indicated in FIG. 1g, in the lattice points of which the channel-forming circular rods are arranged and which consists of a plurality of square elementary cells with side length B, the maximum distance is given by X=B−½ ds.

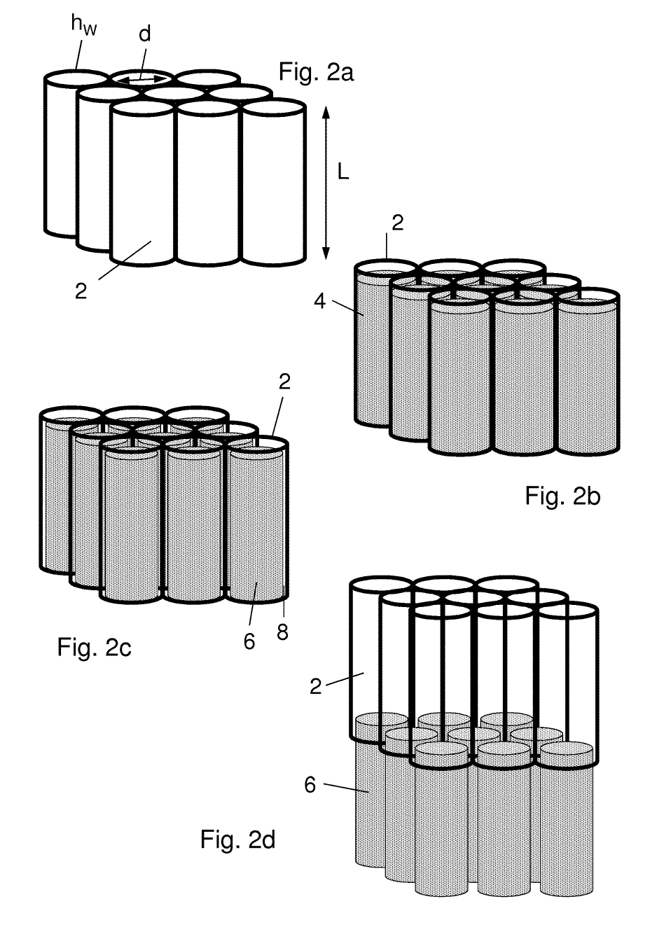

The process sequence shown in FIGS. 2a to 2d first shows in FIG. 2a a bundle of circular cylindrical pipes 2, which is still empty initially and which, in particular, rests on the bottom surface of a confinement tray not shown. In FIG. 2b the pipe bundle is filled with a sol or with a gel 4 formed therefrom which is still unaged. In FIG. 2c an aging of the gel with accompanying shrinkage has occurred, whereby a gap-like interspace 8 filled with syneresis fluid has formed between the cylindrical rods 6 made of aged gel and the pipes 2. In FIG. 2d the gel rods 6 are shown with pipes 2 partially pulled upwards. These are now ready for further processing.

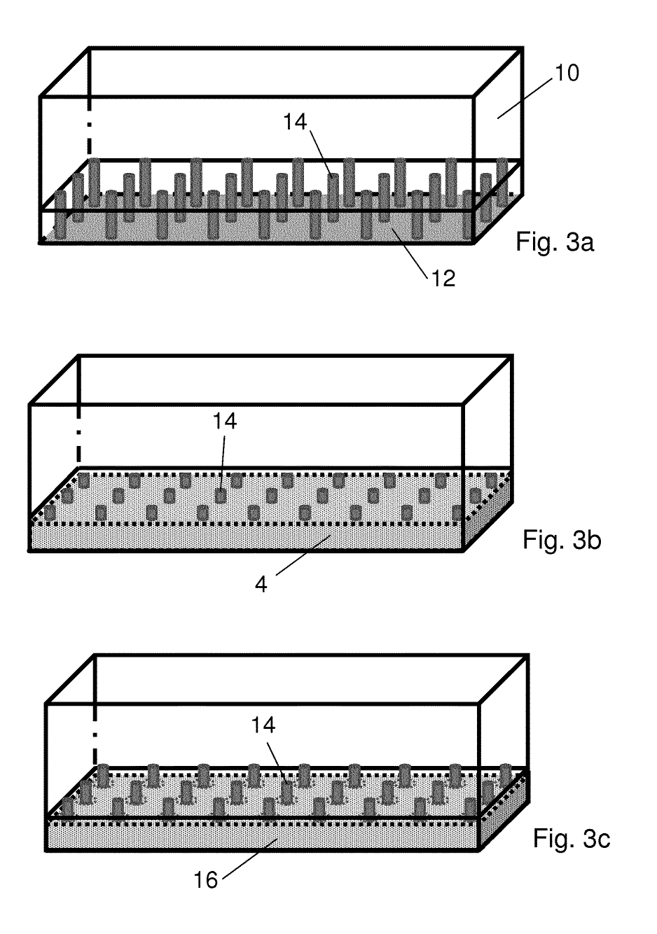

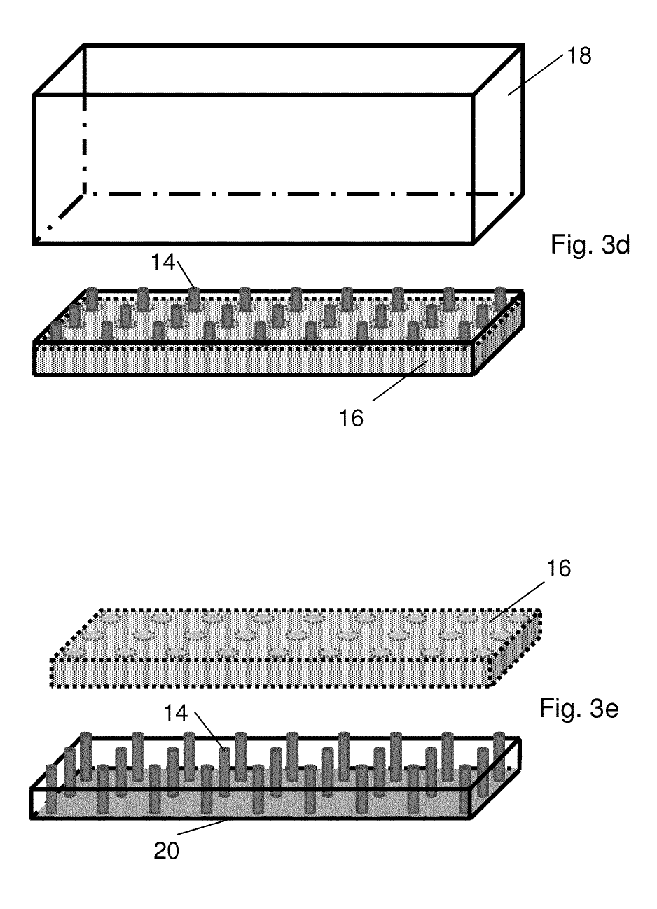

The process sequence shown in FIGS. 3a to 3e first shows in FIG. 3a a cuboid confinement tray 10 with a base plate 12 provided with an arrangement of cylindrical rods 14 in a nail board manner. In the example shown, all rods are approximately of the same length. In FIG. 3b the confinement tray contains a filled sol or a gel formed therefrom which is still unaged, the filling level of which lies just below the rod tips. In FIG. 3c an aging of the gel with accompanying shrinkage has occurred, whereby an interspace 8 is formed between the cylindrical rods 14 and the plate-shaped body 16 made of aged gel. In FIG. 3d a lid part 18 of the confinement tray has been lifted upwards, whereby a base part 20 of the confinement tray with the aged gel body 16 contained therein is uncovered. In FIG. 3e the aged gel body 16 provided with through holes 22 has been lifted out of the base part 20 provided with rods 14 and is ready for further processing.

Production of an Inorganic Organic Hybride Aerogel Granulate

A silicon oxide sol in alcohol is activated by the addition of dilute ethanolic ammonia solution at room temperature. The sol contains 2% aminopropyltriethoxysilane (APTES) as a side component which is added together with the ammonia. This sol is now filled into an open vessel which, as shown in FIG. 2, is provided with a pipe bundle package insert with a pipe inner diameter d=13 mm, a wall thickness h_{w}=1 mm and a length L=90 cm. This insert fills the entire vessel volume. After gelation, the gel pack is aged for 12 h. Thereafter, the pipe bundle insert is removed and excess liquid is decanted off. Thereafter, a diluted solution containing a polymer cross-linking agent reacting with amine groups and a hydrophobicization agent is added. The mixture is allowed to diffuse into the gel for a further 12 hours and to react within the vessel, whereupon excess liquid is removed again. The resulting gel rods are then placed in an autoclave, exchanged for CO₂ and subsequently supercritically dried. As a product, X-aerogel rods with a density of 0.14 g/cm³ and a compressive strength of >10 MPa remain.

Highly Efficient Production of a Silicate-Based Aerogel Granulate

A silica sol is produced in a continuous process and diluted with HMDSO from an SiO₂ content of 10% to a content of 6.6%. This sol is activated at a temperature of 35° C. by admixing diluted ammonia solution at a filling station. At the filling station, there are present 200 I containers which are provided with a honeycomb-like insert filling the cavity completely. The honeycomb mold has a wall thickness of 0.5 mm and a cell diameter of 8 mm. The containers are now individually filled and hermetically closed by means of covers, and then they are stored for 18 h at 70° C. During this time, the mixture undergoes gelling and the gel bodies formed in the honeycomb channels undergo aging, whereby the latter shrink slightly. As a result of the shrinkage, interspaces are formed in which the liquid can circulate (analogously to FIG. 2c). After aging, the containers are opened and the syneresis liquid is drained off. Thereafter, 20 I of diluted mineral acid are added as a catalyst into each vessel, whereby the catalyst is evenly distributed in the interspaces between the gel and the honeycomb wall. The containers are again closed and stored for 8 h at 90° C., whereby the gels undergo hydrophobicization. Thereafter the containers are emptied and the hydrophobicized gel rods are dried in an oven at 150° C. During drying the gel rods spontaneously break up to form an aerogel granulate with a grain size between 4 and 7 mm. The density of the aerogel granulate thus obtained is 0.096 g/cm³ and the thermal conductivity of the loose material is 17.8 mW/mK. By virtue of the processing according to the present invention the gel bodies remain unchanged in the mold until the drying step, thus resulting in a yield of granulate of at least 95%. Compared to mechanically crushed gels, this results in significantly less aerogel dust, which must be regarded as an inferior product.

In an alternative embodiment, the inserts in a large-scale process are not introduced into individual containers, but rather are introduced closely following each other in an elongated process tunnel and thus pass with the gel through the entire production process on a conveyor belt, whereby the syneresis liquid is drawn off in a certain region at the bottom and shortly thereafter the hydrophobicization catalyst is dosed in from the ceiling through an injection system.

Production of a Structured Polyurethane Aerogel Plate

Two freshly prepared solutions in an organic solvent mixture consisting of an isocyanate mixture (component 1) and a polyol with a catalyst (component 2) are mixed with each another and placed into a tray mold into which a uniform, covering arrangement of cylindrical rods according to FIG. 3a) has been inserted. The individual bars have a diameter ds=20 mm, a length Ls=331 mm and a shortest center-to-center distance A=35 mm. The filling level of the sol mixture consisting of components 1 and 2 is H=315 mm. On the upper side, the sol is covered with a suitable perforated plate which engages the rods. After gelation and aging of the gel, the perforated plate is removed and the individual rods are withdrawn. The gel body is then removed from the mold and transferred to an autoclave. The pore liquid contained in the gel body is now extracted in this autoclave by means of supercritical CO₂ and the gel is subsequently subjected to subcritical drying. In the end, a polyurethane aerogel perforated plate of 273 mm thickness remains.

In an alternative embodiment, the mixtures 1 and 2 consist of a solution of resorcinol with a small admixture of acid catalyst and a diluted aqueous formaldehyde solution. In this case, however, it is necessary before supercritical drying to replace the aqueous pore liquid by a suitable solvent medium such as, for example, acetone or ethanol, which is done by solvent exchange.

Industrial Production of an Aerogel Plate

A silicon oxide sol produced in a continuous through-flow reactor is adjusted to a silicate content of 5.7% (measured as SiO₂). The sol is provided with ammonia as a gelling catalyst and is placed in a shell mold in which a nailboard-like insert is present. The insert consists of a base plate onto which has been placed a regular hexagonal arrangement of needle-like rods normally extending to the surface analogously to FIG. 1g with a diameter ds=1.5 mm and a length Ls=70 mm and a shortest center-to-center distance B=10 mm, which corresponds to the edge length of the hexagon. The filling level H of the sol mixture is also 70 mm so that the tips of the rods are just covered. The sol is then covered up with a second plate (cover plate, not shown). After gelation and aging of the gel, the cover plate is removed, the gel plate is removed from the mold and the insert is carefully removed. The gel plate provided with through holes is transferred onto a slow running (7.3 m/h) conveyor belt. This gel body is sprayed from above with a fresh mixture of hydrophobicization agents consisting of 85% HMSO and 15% hydrochloric-acid-diluted ethanol, with the excess liquid forming on the plate being continuously suctioned off via the gas- and liquid-permeable membrane material of the conveyor belt by means of a pump providing a slight underpressure. After an exchange and hydrophobicization time of 6 h at 75° C., the plate is dried by means of solvent drying at 150° C.

Comparative Example

According to a standard procedure without channel-forming elements, which is customary today, the exchange and hydrophobicization time to be expected under otherwise identical conditions is approximately 25 times longer, i.e. 150 h, which is unacceptable for an industrial process.

In a further embodiment, the aerogel plate described in the above example and produced according to the process of the present invention is loaded with aerogel cylinders that fit into the holes. The gel cylinders required for this purpose were prepared previously from a suitably selected polyurethane gel formulation and subsequently dried supercritically from CO₂.

1. A process for the production of an aerogel material with a porosity of at least 0.55 and an average pore size of 10 nm to 500 nm, comprising the following steps:
a) preparing and optionally activating a sol;
b) filling the sol into a casting mold;
c) gelling the sol, whereby a gel is produced, and subsequently aging the gel; at least one of the following steps d) and e)
d) exchanging the pore liquid with a solvent
e) chemically modifying the aged and optionally solvent-exchanged gel using a reacting agent; followed by
f) drying the gel, whereby the aerogel material is formed; characterized in that the casting mold used in step b) is provided with a plurality of channel-forming elements, which are configured such that, along a specified minimum length L defined in the channel direction of the elements, every location of the sol filled into the casting mold has a maximum distance X from a channel-forming element fulfilling the provision that X≦15 mm and L/X>3.

2. The process according to claim 1, wherein the channel-forming elements are configured as bundles of pipes arranged parallel to each other, wherein the casting mold for the sol is formed by the interior spaces of the pipes, and wherein the solvent exchange d) and/or the chemical modification of the gel e) is carried out directly in the casting mold across an interspace between the gel and the channel-forming element formed as a result of a shrinkage during the aging of the gel c.

3. The process according to claim 2, wherein all of the pipes have an identical cross-section.

4. The process according to claim 2, wherein the optionally solvent-exchanged and optionally chemically modified gel is removed as gel rods from the casting mold and wherein subsequently the drying f) is carried out by means of subcritical drying.

5. The process according to claim 1, wherein the channel-forming elements are configured as bundles of rod elements arranged parallel to each other, wherein the casting mold for the sol is formed by a space located between the rod elements, and wherein the rod elements are withdrawable from the casting mold in channel direction after gelation and aging in such manner that a plate-shaped gel body with continuous channels is formed, wherein the solvent exchange d) and/or the chemical modification of the gel e) is carried out by applying solvent or reaction agent.

6. The process according to claim 5, wherein the application of solvent or reaction agent is carried out by forced convection by placing the gel body onto a suction plate that is at least partially permeable and applying on the underside thereof a vacuum so as to draw off the solvent or reaction agent, and wherein new solvent or reaction agent is supplied from above the gel body.

7. The process according to claim 1, wherein
the sol is prepared as a silicon oxide sol in an alcoholic solvent mixture containing at least one acid-catalytically activatable hydrophobicization agent, wherein the volume fraction of the hydrophobicization agent in the sol is 5 to 60%,
the gelation of the sol is initiated by addition of a base;
a chemical modification of the aged gel is carried out, wherein the chemical modification is a hydrophobicization initiated by the release or the addition of at least one hydrophobicization catalyst interacting with the hydrophobicization agent; and
the drying of the gel is carried out by means of subcritical drying.

8. The process according to claim 7, wherein the catalytically activatable hydrophobicization agent is hexamethyldisitoxane (HMDSO).

9. The process according to claim 7, wherein the volume fraction of the hydrophobicization agent in the sol is 20 to 50%, particularly 25% to 40% and more particularly 34% to 38%.

10. The process according to claim 7, wherein the hydrophobicization catalyst is trimethytchlorosilane (TMCS) and/or HCl in an alcoholic solution.

11. The process according to claim 1, wherein the gel is a polymer-based gel, preferably a polyisocyanate-based gel.

12. The process according to claim 1, wherein the optionally activated sol is added to a fiber-based matrix before the gelation.

3. A first precursor product for producing an aerogel plate, consisting of an aerogel plate provided with longitudinal holes, which plate can be produced according to claim 5.

14. A first precursor product for producing an aerogel plate, consisting of a plurality of aerogel rods, which rods can be produced according to claim 2.

15. An aerogel plate, consisting of a first precursor product according to claim 13, into the longitudinal holes of which are inserted correspondingly shaped aerogel rods of a second precursor product according to claim 14.

16. The process according to claim 3, wherein all of the pipes have a hexagonalshaped cross-section.

17. The process according to claim 8, wherein the hydrophobicization catalyst is trimethylchlorosilane (TMCS) and/or HCl in an alcoholic solution.

18. The process according to claim 9, wherein the hydrophobicization catalyst is trimethylchlorosilane (TMCS) and/or HCl in an alcoholic solution.

19. The process according to claim 1, wherein the gel is a polyisocyanate-based gel.
